(19) United States
(12) Patent Application Publication
(10) Pub. No.: US 2015/0232665 A1
(43) Pub. Date: Aug. 20, 2015

(54) LIQUID CRYSTAL ALIGNMENT AGENT, LIQUID CRYSTAL ALIGNMENT FILM AND LIQUID CRYSTAL DISPLAY ELEMENT HAVING THEREOF

(71) Applicant: CHI MEI CORPORATION, Tainan City (TW)

(72) Inventor: Li-Tao HSU, KAOHSIUNG CITY (TW)

(21) Appl. No.: 14/617,933

(22) Filed: Feb. 10, 2015

(30) Foreign Application Priority Data
Feb. 14, 2014 (TW) 103104941

(51) Int. Cl. C08L 79/08; G02F 1/1337; C08K 5/1515

(52) U.S. Cl. CPC C08L 79/08; C08K 5/1515; G02F 1/133723

(57) ABSTRACT

The present invention relates to a liquid crystal alignment composition, a liquid crystal alignment film made by the liquid crystal alignment composition and a liquid crystal display device having the liquid crystal alignment film. The liquid crystal alignment composition includes a polymer (A) and a solvent (B). The polymer (A) is synthesized by a mixture that includes a tetracarboxylic dianhydride component (a) and a diamine component (b). The aforementioned liquid crystal alignment composition has a better UV reliability.

### RELATED APPLICATIONS

This application claims priority to Taiwan Application Serial Number 103104941, filed on Feb. 14, 2014, which is herein incorporated by reference.

### BACKGROUND

1. Field of Invention

The present invention relates to a liquid crystal alignment agent, a liquid crystal alignment film and a liquid crystal display element. More particularly, the present invention provides a liquid crystal alignment agent that has an excellent UV reliability, a liquid crystal alignment film formed by the liquid crystal alignment agent and a liquid crystal display element having thereof.

2. Description of Related Art

In recent years, the requirement of the display quality of the liquid crystal display element is increased more, thus the requirements on the quality or characters of the liquid crystal alignment agent, such as liquid crystal alignment property, ion density or the like, have become stricter than the previous ones. When the ion density of the liquid crystal alignment agent is excess, it easily leads to some issues such as image sticking, of the liquid crystal display, so as to decrease the display quality seriously.

JP Patent publication No. 2009-175684 discloses a liquid crystal alignment film having low ion density, and a diamine compound having piperazine group for preparing the liquid crystal alignment film. The liquid crystal alignment film formed by the diamine compound having piperazine group can improve the defect of the poor display quality caused by excess ion density. However, the aforementioned liquid crystal alignment film: has a defect of poor UV reliability. After the liquid crystal alignment film is exposed by UV light for a period of time, voltage holding ratio of the liquid crystal alignment film substantially decreases, resulting in lowering the contrast of the liquid crystal display element.

According to the aforementioned description, for meeting the requirements of the liquid crystal display element, there is a need to provide a liquid crystal alignment agent having excellent UV reliability, so as to form a liquid crystal alignment film. When the liquid crystal alignment film is applied in a liquid crystal display element, such liquid crystal display element still has high voltage holding ratio after being exposed by UV light for a long time.

### SUMMARY

Therefore, an aspect of the present invention provides a liquid crystal alignment agent. The liquid crystal alignment agent comprises a polymer (A) and a solvent (B), and the liquid crystal alignment agent can improve UV reliability.

Another aspect of the present invention provides a liquid crystal alignment film. The liquid crystal alignment film is formed by the aforementioned liquid crystal alignment agent.

A further aspect of the present invention provides a liquid crystal display element. The liquid crystal display element includes the aforementioned liquid crystal alignment film.

According to the aforementioned aspects, the liquid crystal alignment agent comprising the polymer (A) and the solvent (B) all of which are described in details as follows.

### LIQUID CRYSTAL ALIGNMENT AGENT

### Polymer (A)

The polymer (A) is selected from the group consisting of polyamic acid, polyimide, polyimide series block-copolymer and a combination thereof. The polyimide series block-copolymer is selected from the group consisting of polyamic acid block-copolymer, polyimide block-copolymer, polyamic acid-polyimide block-copolymer and a combination thereof.

The polyamic acid, polyimide, and polyimide series block-copolymer of the polymer (A) all synthesized by reacting a mixture that includes a tetracarboxylic dianhydride component (a) and a diamine component (b). The tetracarboxylic dianhydride component (a), the diamine component (b) and a method of producing the polymer (A) all of which are described in details as follows.

### Tetracarboxylic Dianhydride Component (a)

Tetracarboxylic Dianhydride Compound (a-1)

The tetracarboxylic dianhydride component (a) is selected from a group consisting of at least one tetracarboxylic dianhydride compound (a-1) having a structure of formula (I) to formula (III):

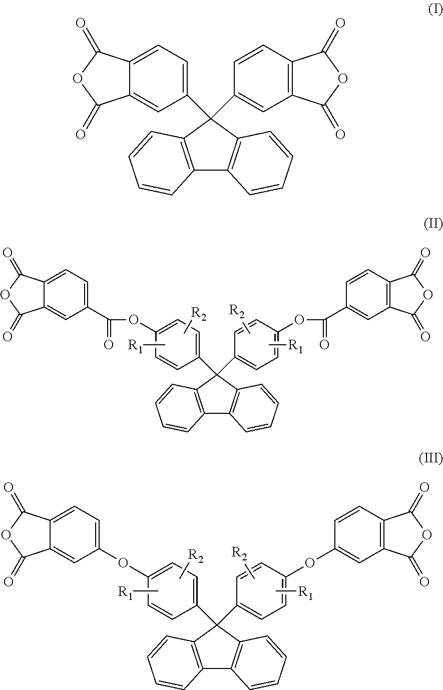

in formula (II) and formula (III), R₁ represents a hydrogen atom, an alkyl group of 1 to 6 carbon atoms, a single ring or condensed polycyclic aromatic group of 6 to 14 carbon atoms. For example, the alkyl group of 1 to 6 carbon atoms can be methyl, ethyl, n-propyl, iso-propyl, n-butyl, iso-butyl, sec-butyl, tert-butyl, n-pentyl, n-hexyl or the like, and the single ring or condensed polycyclic aromatic group can be phenyl, o-tolyl, m-tolyl, p-tolyl, 1-naphthyl, 2-naphthyl, 1-anthryl, 2-anthryl, 9-anthryl or the like. Preferably, R₁ represents methyl, ethyl, iso-propyl, tert-butyl, phenyl and the like. R₂ represents hydrogen atom, an alkyl group of 1 to 6 carbon atoms, a single ring or condensed polycyclic aromatic group of 6 to 14 carbon atoms. For example, the alkyl group of 1 to 6 carbon atoms can be methyl, ethyl, n-propyl, iso-propyl, n-butyl, iso-butyl, sec-butyl, tert-butyl, n-pentyl, n-hexyl or the like, and the single ring or condensed polycyclic aromatic group can be phenyl, o-tolyl, m-tolyl, p-tolyl, 1-naphthyl, 2-naphthyl, 1-anthryl, 2-anthryl, 9-anthryl or the like. Preferably, R₁ represents the hydrogen atom, the methyl, the ethyl, the iso-propyl, the tert-butyl, the phenyl and the like, and more preferably the hydrogen atom.

For example, the tetracarboxylic dianhydride compound (a-1) having a structure of formula (II) can be 9,9-bis(4′-hydroxyphenyl)fluorene-bis(trimellitate anhydride), 9,9-bis(4′-hydroxy-3′-phenylphenyl)fluorene-bis(trimellitate anhydride), 9,9-bis(4′-hydroxy-2′-phenylphenyl)fluorene-bis(trimellitate anhydride), 9,9-bis(4′-hydroxy-3′-methylphenyl)fluorene-bis(trimellitate anhydride), 9,9-bis(4′-hydroxy-2′-methylphenyl)fluorene-bis(trimellitate anhydride), 9,9-bis(4′-hydroxy-3′-ethylphenyl)fluorene-bis(trimellitate anhydride), 9,9-bis(4′-hydroxy-2′-ethylphenyl)fluorene-bis(trimellitate anhydride), 9,9-bis(4′-hydroxy-3′-propylphenyl)fluorene-bis(trimellitate anhydride), 9,9-bis(4′-hydroxy-2′-propylphenyl)fluorene-bis(trimellitate anhydride), 9,9-bis(4′-hydroxy-3′-butylphenyl)fluorene-bis(trimellitate anhydride), 9,9-bis(4′-hydroxy-2′-butylphenyl)fluorene-bis(trimellitate anhydride), 9,9-bis(4′-hydroxy-3′-tertbutylphenyl)fluorene-bis(trimellitate anhydride), 9,9-bis(4′-hydroxy-2′-tertbutylphenyl)fluorene-bis(trimellitate anhydride), and the like. Preferably, the tetracarboxylic dianhydride compound (a-1) having a structure of formula (II) can be 9,9-bis(4′-hydroxyphenyl)fluorene-bis(trimellitate anhydride), 9,9-bis(4′-hydroxy-3′-phenylphenyl)fluorene-bis(trimellitate anhydride), 9,9-bis(4′-hydroxy-2′-phenylphenyl)fluorene-bis(trimellitate anhydride), 9,9-bis(4′-hydroxy-3′-methylphenyl)fluorene-bis(trimellitate anhydride), and 9,9-bis(4′-hydroxy-2′-methylphenyl)fluorene-bis(trimellitate anhydride).

For example, the tetracarboxylic dianhydride compound (a-1) having a structure of formula (III) can be 9,9-bis[4-(3,4-dicarboxylicphenoxy)phenyl]fluorine dianhydride, 9,9-bis[4-(3,4-dicarboxylicphenoxy)3-phenylphenyl]fluorine dianhydride, 9,9-bis[4-(2,3-dicarboxylicphenoxy)3-phenylphehyl]fluorine dianhydride, 9,9-bis[4-(3,4-dicarboxylicphenoxy)2-phenylphenyl]fluorine dianhydride, 9,9-bis[4-(2,3-dicarboxylicphenoxy)2-phenylphehyl]fluorine dianhydride, 9,9-bis[4-(3,4-dicarboxylicphenoxy)3-methylphehyl]fluorine dianhydride, 9,9-bis[4-(2,3-dicarboxylicphenoxy)3-methylphenyl]fluorine dianhydride, 9,9-bis[4-(3,4-dicarboxylicphenoxy)2-methylphenyl]fluorine dianhydride, 9,9-bis[4-(3,4-dicarboxylicphenoxy)2-methylphenyl]fluorine dianhydride, 9,9-bis[4-(3,4-dicarboxylicphenoxy)3-ethylphenyl]fluorine dianhydride, 9,9-bis[4-(2,3-dicarboxylicphenoxy)3-ethylphenyl]fluorine dianhydride, 9,9-bis[4-(3,4-dicarboxylicphenoxy)2-ethylphenyl]fluorine dianhydride, 9,9-bis[4-(2,3-dicarboxylicphenoxy)2-ethylphenyl]fluorine dianhydride, 9,9-bis[4-(3,4-dicarboxylicphenoxy)3-propylphenyl]fluorine dianhydride, 9,9-bis[4-(2,3-dicarboxylicphenoxy)3-propylphenyl]fluorine dianhydride, 9,9-bis[4-(34-dicarboxylicphenoxy)2-propylphenyl]fluorine dianhydride, 9,9-bis[4-(2,3-dicarboxylicphenoxy)2-propylphenyl]fluorine dianhydride, 9,9-bis[4-3,4-dicarboxylicphenoxy)3-butylphenyl]fluorine dianhydride, 9,9-bis[4-(2,3-dicarboxylicphenoxy)3-butylphenyl]fluorine dianhydride, 9,9-bis[4-(3,4-dicarboxylicphenoxy)2-butylphenyl]fluorine dianhydride, 9,9-bis[4-(2,3-dicarboxylicphenoxy)2-butylphenyl]fluorine dianhydride, 9,9-bis[4-(3,4-dicarboxylicphenoxy)3-tertbutylphenyl]fluorine dianhydride, 9,9-bis[4-(2,3-dicarboxylicphenoxy)3-tertbutylphenyl]fluorine dianhydride, 9,9-bis[4-(3,4-dicarboxylicphenoxy)2-tertbutylphenyl]fluorine dianhydride, 9,9-bis[4-(2,3-dicarboxylicphenoxy)2-tertbutylphenyl]fluorine dianhydride or the like. Preferably, the tetracarboxylic dianhydride compound (a-1) having a structure of formula (III) is 9,9-bis[4-(3,4-dicarboxylicphenoxy)phenyl]fluorine dianhydride, 9,9-bis[4-(3,4-dicarboxylicphenoxy)3-phenylphenyl]fluorine dianhydride, 9,9-bis[4-(3,4-dicarboxylicphenoxy)2-phenylphenyl]fluorine dianhydride, 9,9-bis[4-(3,4-dicarboxylicphenoxy)3-methylphenyl]fluorine dianhydride, and 9,9-bis[4-(3,4-dicarboxylicphenoxy)2-methylphenyl]fluorine dianhydride.

Based on a total amount of the tetracarboxylic dianhydride component (a) as 100 moles, an amount of the tetracarboxylic dianhydride compound (a-1) is 1 mole to 80 moles, preferably 3 moles to 70 moles, and more preferably 5 moles to 60 moles.

When the tetracarboxylic dianhydride component (a) does not include the tetracarboxylic dianhydride compound (a-1), the liquid crystal alignment agent has a defect of poor UV reliability.

Other Tetracarboxylic Dianhydride Compound (a-2)

In the present invention, the tetracarboxylic dianhydride component (a) can selectively include an other tetracarboxylic dianhydride compound (a-2) except the aforementioned tetracarboxylic dianhydride compound (a-1).

The other tetracarboxylic dianhydride compound (a-2) can be selected from the group consisting of an aliphatic tetracarboxylic dianhydride compound, an alicyclic tetracarboxylic dianhydride compound, an aromatic tetracarboxylic dianhydride compound, the tetracarboxylic dianhydride compound having a structure of formula (V-1) to (V-6) and the like. The aforementioned other tetracarboxylic dianhydride compound (a-2) can be used alone or a combination two or more.

For example, the aliphatic tetracarboxylic dianhydride compound includes but is not limited ethane tetracarboxylic dianhydride, butane tetracarboxylic dianhydride and the like.

For example, the alicyclic tetracarboxylic dianhydride compound includes but is not limited 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dichloro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexane tetracarboxylic dianhydride, cis-3,7-dibutylcycloheptyl-1,5-diene-1,2,5,6-tetracarboxylic dianhydride, 2,3,5-tricarboxy cyclopentyl acetic acid dianhydride, dicyclo[2.2.2]-octyl-7-ene-2,3,5 6-tetracarboxylic dianhydride and the like.

For example, the aromatic tetracarboxylic dianhydride compound includes but is not limited 3,4-dicarboxy-1,2,3,4-tetrahydronaphthalene-1-succinic acid dianhydride, pyromellitic dianhydride, 2,2′,3,3′-benzophenone tetracarboxylic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-diphenylethane tetracarboxylic dianhydride, 3,3′,4,4′-dimethyl diphenylsilane tetracarboxylic dianhydride, 3,3′,4,4′-tetraphenylsilane tetracarboxylic dianhydride, 1,2,3,4-furan tetracarboxylic dianhydride, 2,3,3′,4′-biphenyl ether tetracarboxylic dianhydride, 3,3′,4,4′-biphenylether tetracarboxylic dianhydride, 4,4′-bis(3,4-dicarboxyphenoxy)diphenylsulfide dianhydride, 2,3,3′,4′-biphenylsulfide tetracarboxylic dianhydride, 3,3′,4,4′-biphenylsulfide tetracarboxylic dianhydride, 4,4′-bis(3,4-dicarboxyphenoxyl)diphenylsulfone dianhydride, 4,4′-bis(3,4-dicarboxyphenoxyl)diphenylpropane dianhydride, 3,3′,4,4′-perfluoroisopropylidene diphenyl dicarboxylic dianhydride, 2,2′3,3′-biphenyl tetracarboxylic dianhydride, 2,3,3′,4′-biphenyl tetracarboxylic dianhydride, 3,3′,4,4′-biphenyl tetracarboxylic dianhydride, bis(phthalic acid)phenylphosphine oxide dianhydride, p-phenylene-bis(triphenyl phthalic acid)dianhydride, m-phenylene-bis(triphenylphthalic acid)dianhydride, bis(triphenylphthalic acid)-4,4′-diphenyl ether dianhydride, bis(triphenylphthalic acid)-4,4′-diphenyl methane dianhydride, ethylene glycol-bis(anhydrotrimelitate), propylene glycol-bis(anhydrotrimelitate), 1,4-butanediol bis(anhydrotrimelitate), 1,6-hexyanediol bis(anhydrotrimelitate), 1,8-octanediol bis(anhydrotrimelitate), 2,2-bis(4-hydroxyphenyl)propane-bis(anhydrotrimelitate), 2,3,4,5tetrahydrofurantetracarboxylic dianhydride, 1,3,3a,4,5,9b-Hexahydro-5-(tetrahydro-2,5-dioxofuran-3-yl)naphtho[1,2-c]furan-1,3-dione, 1,3,3a,4,5,9b-Hexahydro-5-methyl-5-(tetrahydro-2,5-dioxofuran-3-yl)naphtho[1,2-c]furan-1,3-dione, 1,3,3a,4,5,9b-Hexahydro-5-ethyl-5-(tetrahydro-2,5-dioxofuran-3-yl)naphtho[1,2-c]furan-1,3-dione, 1,3,3a,4,5,9b-Hexahydro-7-methyl-5-(tetrahydro-2,5-dioxofuran-3-yl)naphtho[1,2-c]furan-1,3-dione, 1,3,3a,4,5,9b-Hexahydro-7ethyl-5-(tetrahydro-2,5-dioxofuran--3yl)naphtho[1,2-c]furan-1,3-dione, 1,3,3a,4,5,9b-Hexahydro-8-methyl-5-(tetrahydro-2,5-dioxofuran-3-yl)naphtho[1,2-c]furan-1,3-dione, 1,3,3a,4,5,9b-Hexahydro-8-ethyl-5-(tetrahydro-2,5-dioxofuran-3yl)naphtho[1,2-c]furan-1,3-dione, 1,3,3a,4,5,9b-Hexahydro-5,8-dimethyl-5-(tetrahydro-2,5-dioxofuran-3-yl)naphtho[1,2-c]furan-1,3-dione, 5-(2,5-dioxotetrahydrofuran)-3-methyl-3-cyclohexene-1,2-dicarboxylic dianhydride and the like.

The other tetracarboxylic dianhydride compound having a structure of formula (V-1) to (V-6) all of which are showed as follows:

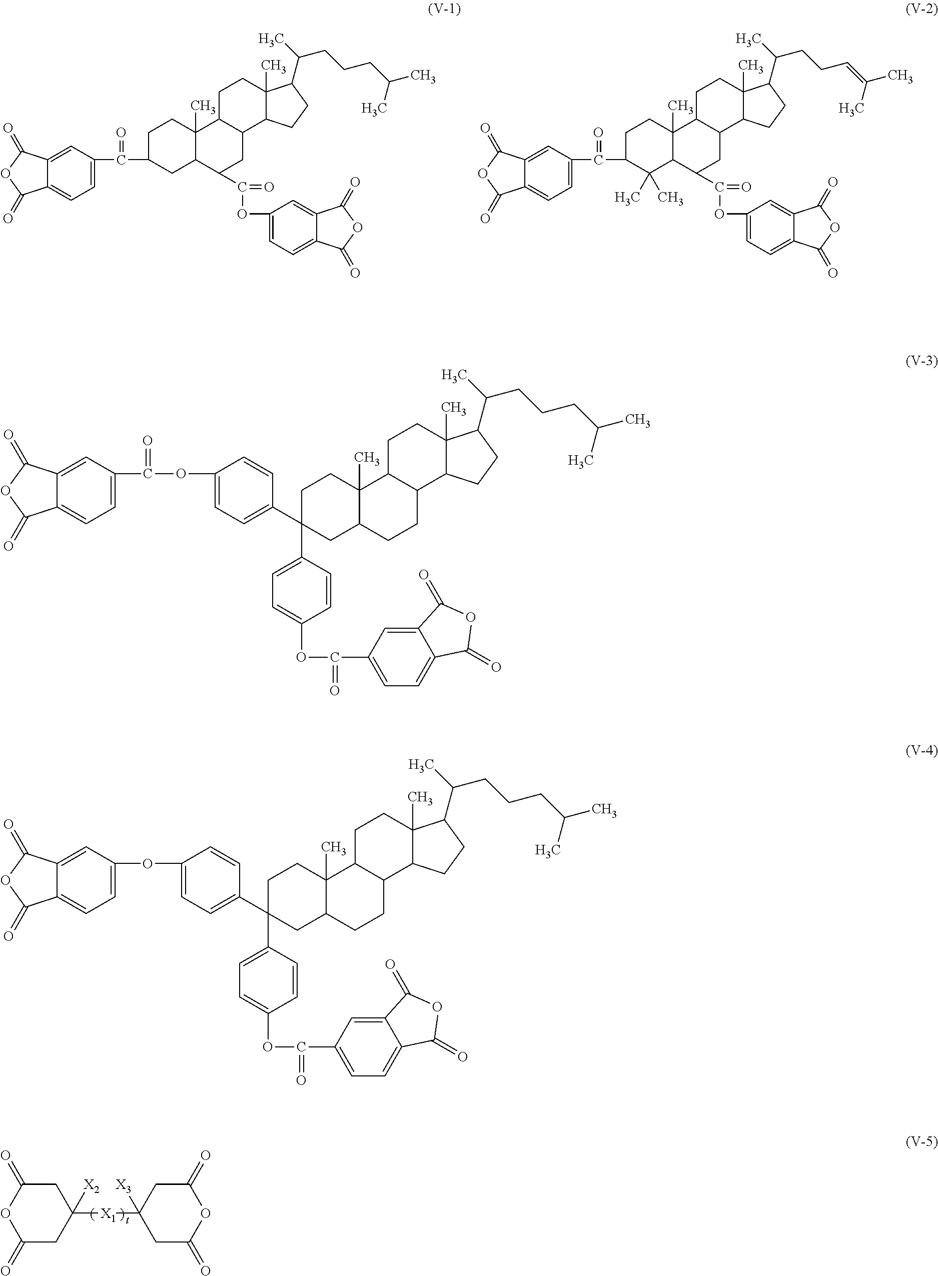

In formula (V-5), X₁ is a divalent group having an aromatic group; t is an integer of 1 or 2; X₂ and X₃ can be the same or different, and X₂ and X₃ respectively are a hydrogen atom or alkyl group. Preferably, the other tetracarboxylic dianhydride compound having a structure of formula (V-5) can be selected from the group consisting of a compound having a structure of formula (V-5-1) to (V-5-3):

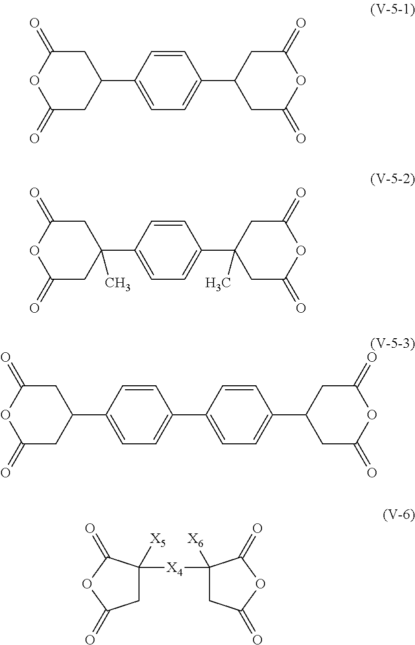

In formula (V-6), X₄ is a divalent group having an aromatic group; X₅ and X₆ can be the same or different from each other, and X₅ and X₆ respectively are a hydrogen atom or an alkyl group. Preferably, the other tetracarboxylic dianhydride compound having a structure of formula (V-6) can be selected from the group consisting of the compounds having a structure of formula (V-6-1):

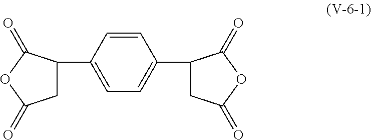 [SMILES: O=C1CC(c2ccc(C3CC(=O)OC3=O)cc2)C(=O)O1]

Preferably, the other tetracarboxylic dianhydride compound (a-2) includes but is not limited butane tetracarboxylic dianhydride, 1,2,3,4-cyclobutane tetracarboxylic dianhydride, 1,2,3,4-cyclopentane tetracarboxylic dianhydride, 2,3,5-tricarboxy cyclopentyl acetic acid dianhydride, 1,2,4,5-cyclohexane tetracarboxylic dianhydride, 3,4-dicarboxy-1,2,3,4-tetrahydronaphthalene-1-succinic acid dianhydride, pyromellitic dianhydride, 3,3′,4,4′-benzophenone tetracarboxylic dianhydride and 3,3′,4,4′-biphenylsulfone tetracarboxylic dianhydride.

Based on the total amount of the tetracarboxylic dianhydride component (a) as 100 moles, an amount of the other tetracarboxylic dianhydride compound (a-2) is 20 moles to 99 moles, preferably 30 moles to 97 moles, and more preferably 40 moles to 95 moles.

### Diamine Component (b)

Diamine Compound (b-1)

The diamine component (b) of the present invention can include at least one diamine compound (b-1) having a structure of formula (IV):

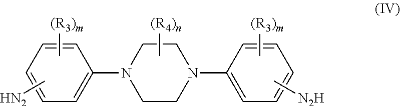

in the formula (IV), R₃ independently represents a monovalent organic group; R₄ independently represents a monovalent organic group; m represents an integer of 0 to 3; and n represents an integer of 0 to 4.

In the formula (IV), R₃ can independently an alkyl group of 1 to 10 carbon atoms, an alkoxy group of 1 to 10 carbon atoms, an acetyl amino group, a fluorine atom, a chloride atom or a bromine atom. R₄ can independently represents an alkyl group of 1 to 3 carbon atoms.

In the diamine compound (b-1) having a structure of formula (IV), phenyl groups of the two ends can include p-amino groups.

The diamine compound (b-1) having a structure of formula (IV) can include but be not limited the diamine compound having a structure of formula (IV-1) to (IV-15):

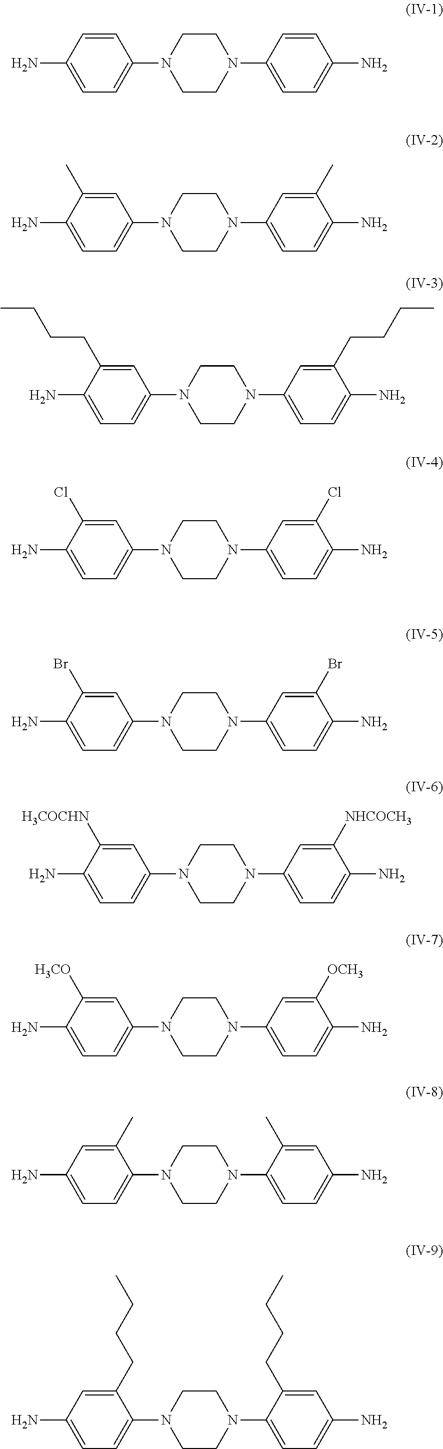

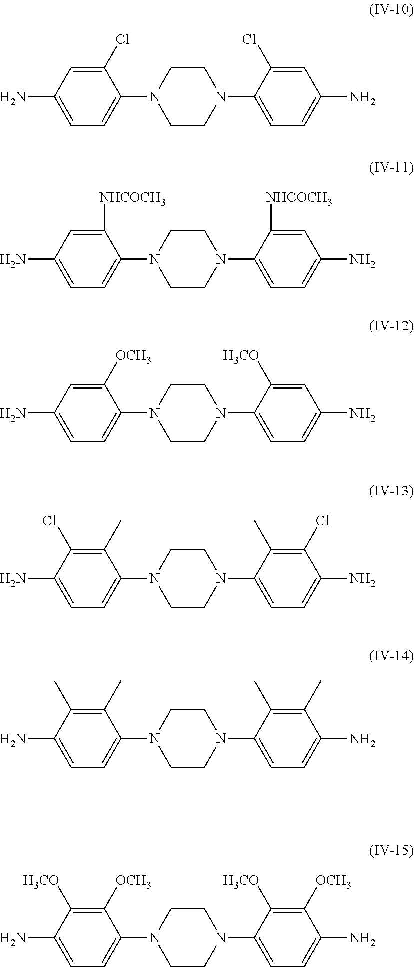

The diamine compound (b-1) having a structure of formula (IV) can be used alone or in a combination of two or more.

Based on a total amount of the diamine component (b) as 100 moles, an amount of the diamine compound (b-1) is 1 mole to 80 moles, preferably 3 moles to 70 moles, and more preferably5 moles to 60 moles.

When the diamine component (b) does not include the diamine compound (b-1), the liquid crystal alignment agent has a defect of poor UV reliability.

Other Diamine Compound (b-2)

The diamine component (b) of the present invention can selectively include an other diamine compound (b-2) except the aforementioned diamine compound (b-1). The other diamine compound (b-2) includes but is not limited 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminoctadecane, 1,2-bis(3-aminopropoxyl)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadiene diamine, tricyclo(6.2.1.0^{2,7})-undecenoyl dimethyldiamine, 4,4′-methylenebis (cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4-aminophenyl)-1,3,3-trimethylindane, hexahydro-4,7-methanoindanylenedimethylenediamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1.4-(4-aminophenoxyl)benzene, 1,3-bis(4-aminophenoxy)benzene, 1,3-bis(3-aminophenoxyl)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylene)bisaniline, 4,4′-(m-phenylene isopropylene)bisaniline, 2,2′-bis[4-(4-amino-2-trifluoromethyl phenoxy)phenyl]hexafluoropropane, 4,4′-bis[(4-amino-2-trifluoro)phenoxy]octafluorophenyl benzene, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, and the other diamine compound having a structure of formula (VI-1) to (VI-30):

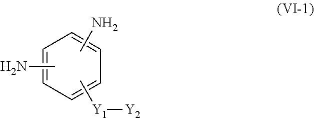

In the formula (VI-1), Y₁ is

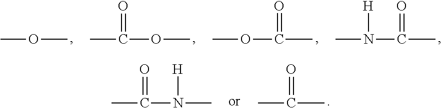

Y₂ is a steroid-containing group, a trifluoro methyl group, a fluoro group, an alkyl group of 2 to 30 carbon atoms or an monovalent nitrogen-containing cyclic group derived from pyridine, pyrimidine, triazine, piperidine, piperazine and the like.

Preferably, the diamine compound having a structure of formula (VI-1) is 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene or the diamine compound having a structure of formula (VI-1-1) to (VI-1-6):

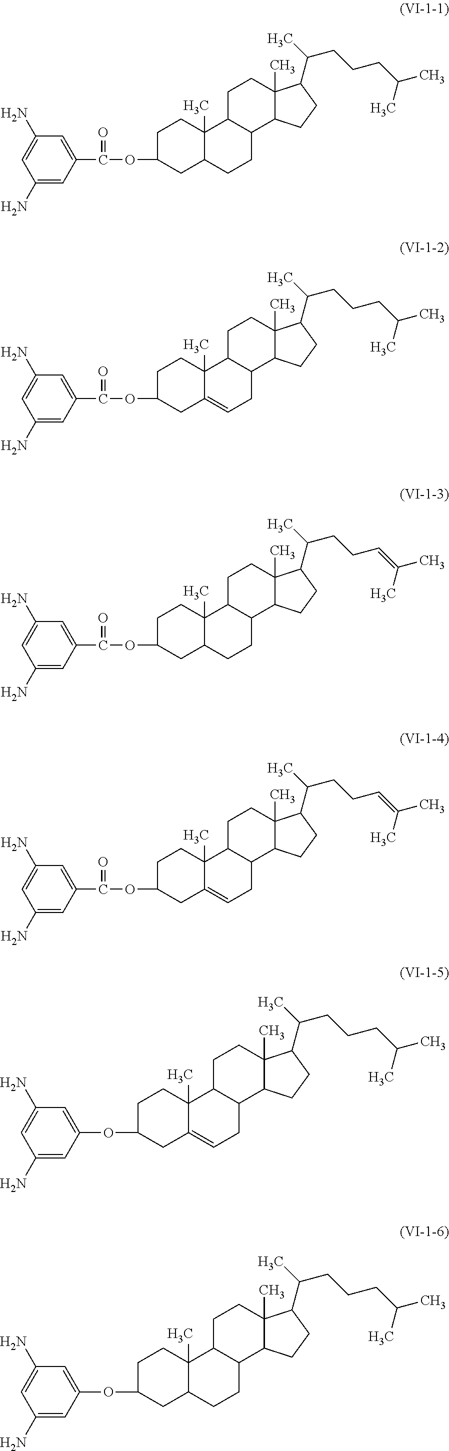 [SMILES: CC(C)CCCC(C)C1CCC2C3CCC4CC(OC(=O)c5cc(N)cc(N)c5)CCC4(C)C3CCC12C ; CC(C)CCCC(C)C1CCC2C3CC=C4CC(OC(=O)c5cc(N)cc(N)c5)CCC4(C)C3CCC12C ; CC(C)=CCCC(C)C1CCC2C3CCC4CC(OC(=O)c5cc(N)cc(N)c5)CCC4(C)C3CCC12C ; CC(C)=CCCC(C)C1CCC2C3CC=C4CC(OC(=O)c5cc(N)cc(N)c5)CCC4(C)C3CCC12C ; CC(C)CCCC(C)C1CCC2C3CC=C4CC(Oc5cc(N)cc(N)c5)CCC4(C)C3CCC12C ; CC(C)CCCC(C)C1CCC2C3CCC4CC(Oc5cc(N)cc(N)c5)CCC4(C)C3CCC12C]

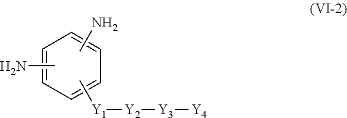

in the formula (VI-2), Y₁ is

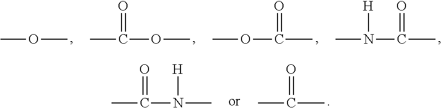

Y₃ and Y₄ is a divalent group of an alicyclic ring, an aromatic ring or a heterocyclic ring. Y₅ is an alkyl group of 3 to 18 carbon atoms, an alkoxy group of 3 to 18 carbon atoms, a fluoroalky group of 1 to 5 carbon atoms, a fluoroalkoxy group of 1 to 5 carbon atoms, a cyano group or a halogen atom.

Preferably, the other diamine compound having a structure of formula (VI-2) is the diamine compound having a structure of formula (VI-2-1) to (VI-2-13):

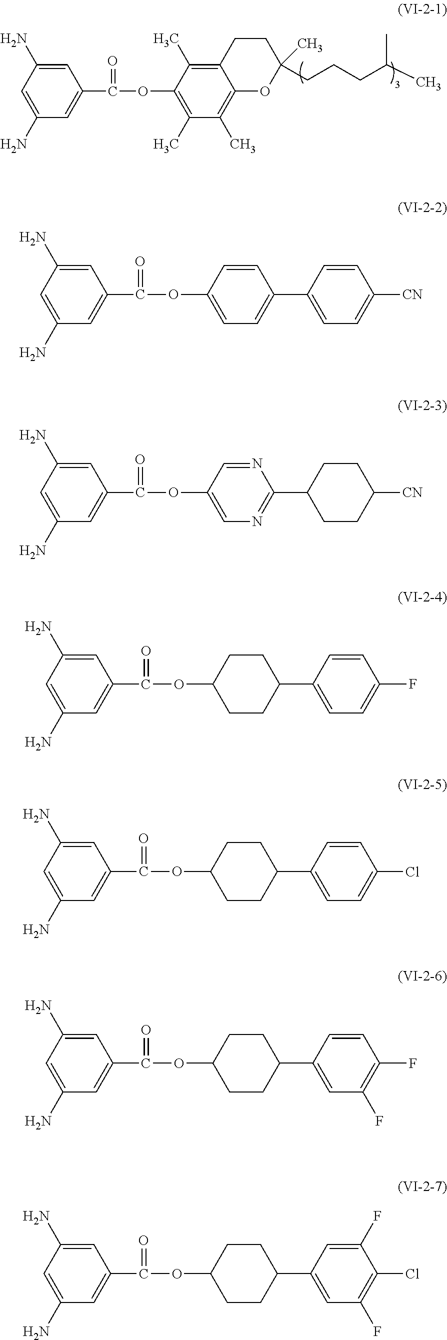

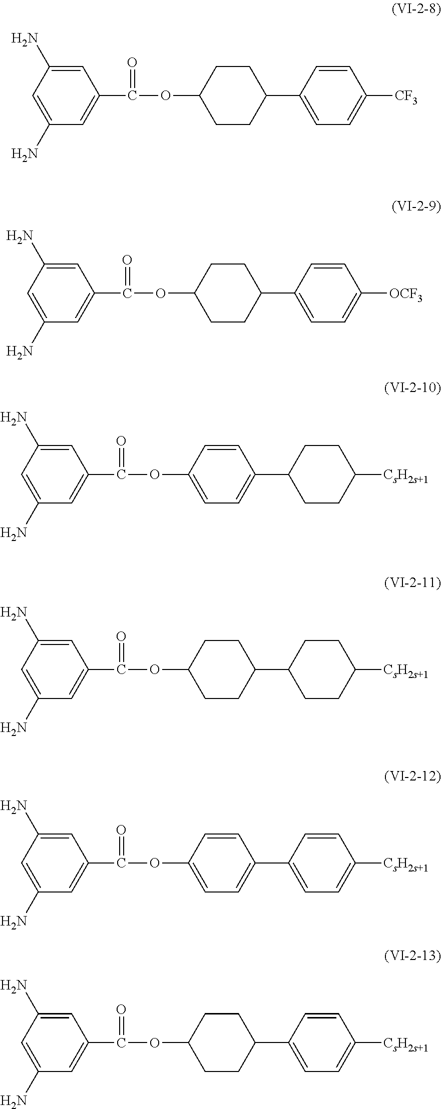

in the formula (VI-2-10) to (VI-2-13), s is an integer of 3 to 12.

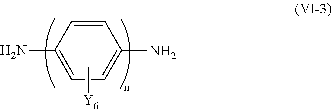

in the formula (VI-3), Y₆ is a hydrogen atom, an acyl group of 1 to 5 carbon atoms, an alkyl group of 1 to 5 carbon atoms, an alkoxy group of 1 to 5 carbon atoms, or a halogen atom. In every repeating unit, Y₆ can be the same or different. u is an integer of 1 to 3.

The diamine compound having a structure of formula (VI-3) preferably is selected from the group consisting of (1) when u is 1, such as p-diaminobenzene, m-diaminobenzene, o-diaminobenzene, 2,5-diaminotoluene and the like; (2) when u is 2, such as 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, 4,4′-diamino-2,2′-bis(trichloromethyl)biphenyl and the like; (3) when u is 3, such as 1,4-bis(4′-aminophenyl)benzene and the like, and more preferably p-diaminobenzene, 2,5-diaminotoluene, 4,4′-diaminobiphenyl, 3,3′-dimethoxy-4,4′-diaminobiphenyl or 1,4-bis(4′-aminophenyl)benzene.

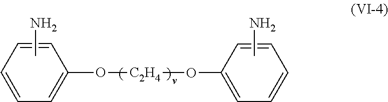

In the formula (VI-4), v is an integer of 2 to 12.

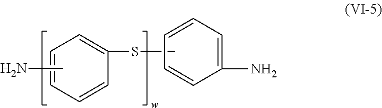

In the formula (VI-5), w is an integer of 1 to 5. Preferably, the formula (VI-5) is selected from 4,4′-diamino-diphenylsulfide.

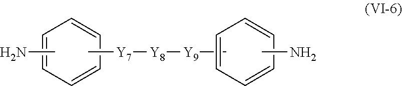

In the formula (VI-6), Y₇ and Y₉ can be the same or different, and Y₇ and Y₉ respectively are divalent group; Y₈ is a divalent nitrogen-containing cyclic group derived from pyridine, pyrimidine, triazine, piperidine, piperazine and the like.

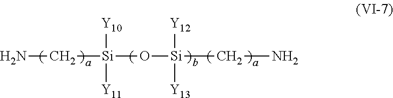

In the formula (VI-7), Y₁₀, Y₁₁, Y₁₂ and Y₁₃ can be the same or different, and Y₁₀, Y₁₁, Y₁₂ and Y₁₃ respectively are an alkyl group of 1 to 12 carbon atoms. a is an integer of 1 to 3, and b is an integer of 1 to 20.

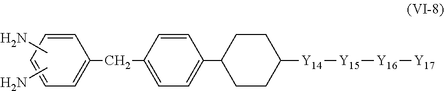

In the formula (VI-8), Y₁₄ is —O— or a cyclohexylene. Y₁₅ is —CH₂—. Y-₁₆ is phenylene or cyclohexylene. Y₁₇ is a hydrogen atom or a heptyl group.

Preferably, the diamine compound having a structure of formula (VI-8) is selected from the group consisting of the diamine compound having a structure of formula (VI-8-1) to (VI-8-2);

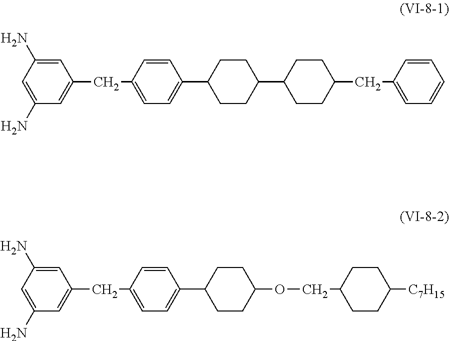

The other diamine compound having a structure of formula (VI-9) to (VI-30) are showed as follows:

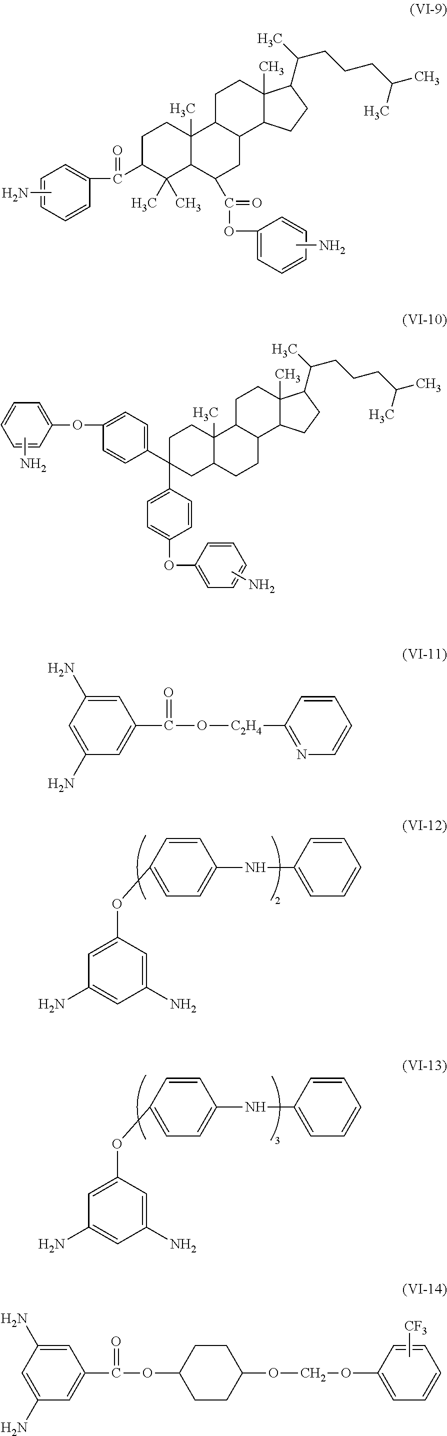

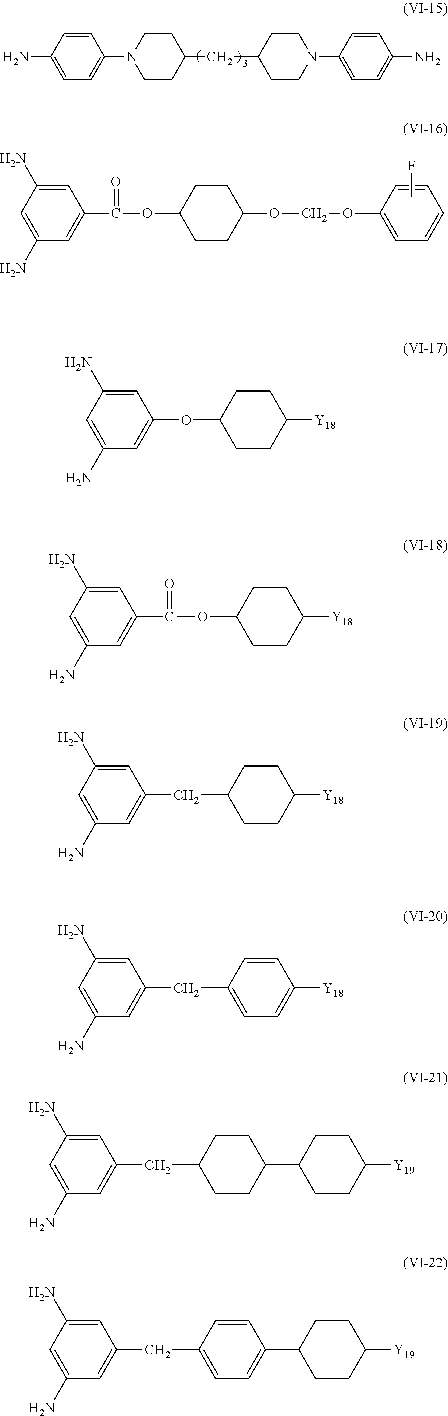

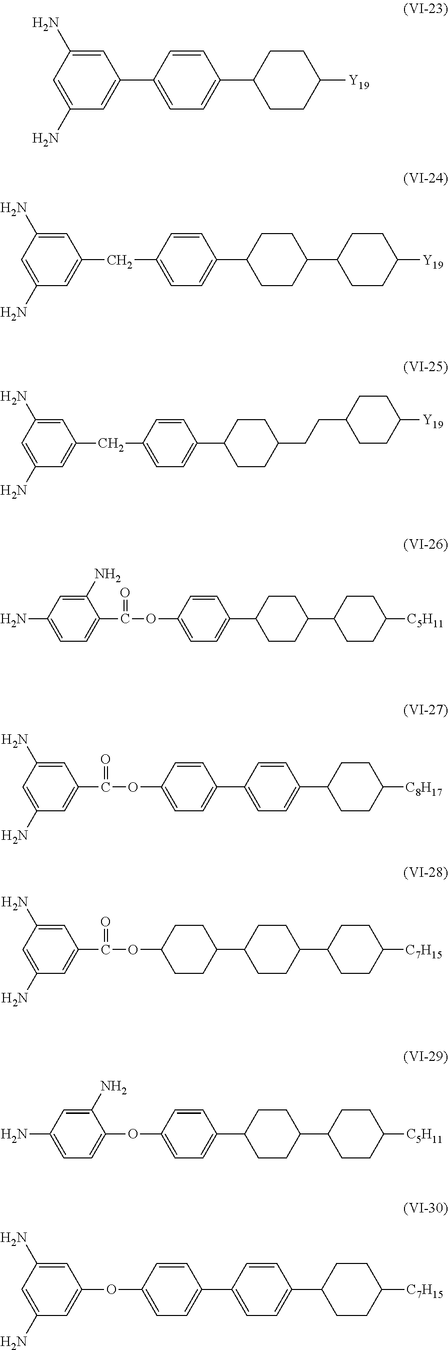

in the formula (VI-17) to (VI-25), Y₁₈ preferably is an alkyl group of 1 to 10 carbon atoms, or an alkoxy group of 1 to 10 carbon atoms. Y₁₉ preferably is a hydrogen atom, an alkyl group of 1 to 10 carbon atoms, or an alkoxy group of 1 to 10 carbon atoms.

Preferably, the other diamine compound (b-2) includes but is not limited 1,2-diaminoethane, 4,4′-diaminodicyclohexylmethane, 4,4′-diaminodiphenyl-methane, 4,4′-diaminodiphenylether, 5-[4-(4-n-amylcyclohexyl)cyclohexyl]phenylmethylene-1,3-diamino benzene, 1,1-bis[4-(4-aminophenoxy)phenyl]-4-(4-ethylphenyl)cyclohexane, 2,4-diaminophenyl ethyl formate, the formula (VI-1-1), the formula (VI-1-2), the formula (VI-1-5), the formula (VI-2-1), the formula (VI-2-11), the formula (VI-8-1) the formula (VI-26), the formula (VI-29), p-diaminobenzene, m-diaminobenzene, or o-diaminobenzene.

The aforementioned other diamine compound (b-2) can be used alone or in a combination of two or more.

Based on the total amount of the diamine compound (b) as 100 moles, an amount of the aforementioned other diamine compound (b-2) is 20 moles to 99 moles, preferably 30 moles to 97 moles, and more preferably 40 moles to 95 moles.

### Method of Producing Polymer (A)

Method of Producing Polyamic Acid

A mixture is dissolved in a solvent, and the mixture includes a tetracarboxylic dianhydride component (a) and a diamine component (b). A polycondensation reaction is performed at 0° C. to 100° C. After 1 hr to 24 hrs, the aforementioned reacting solution is subjected to a reduced pressure distillation by an evaporator, or the aforementioned reacting solution was poured into a great quantity poor solvent to obtain a precipitate. Then, the precipitate is dried by a method of reduced pressure drying to produce polyamic acid.

Based on an amount of the diamine component (b) as 100 moles, the amount of the tetracarboxylic dianhydride component (a) preferably 20 moles to 200 moles, and more preferably 30 moles to 120 moles.

The solvent used in the polycondensation reaction can be the same as or different from the solvent in the liquid crystal alignment agent. The solvent used in the polycondensation reaction does not have any special limitations. The solvent needs to dissolve the reactant and the product. Preferably, the solvent includes but is not limited (1) aprotic solvent, such as N-methyl-2-pyrrolidinone (NMP), N,N-dimethylacetamide, N,N-dimethylformamide, dimethylsulfoxide, γ-butyrolactone, tetramethylurea, hexmethyl phosphoric acid triamino and the like; (2) phenolic solvent, such as m-cresol, xylenol, phenol, halogenated phenol and the like. Based on the mixture as 100 parts by weight, the amount of the solvent used in the polycondensation reaction preferably 200 to 2000 parts by weight, and more preferably 300 to 1800 parts by weight.

Particularly, in the polycondensation reaction, the solvent can combine with suitable poor solvent. The formed polyamic acid won't precipitate in the poor solvent. The poor solvent can be used alone or in a combination of two or more, and the poor solvent includes but is not limited (1) alcohols, such as methanol, ethanol, isopropanol, cyclohexanol, ethylene glycol, propylene glycol, 1,4-butanediol, triethyleneglycol and the like; (2) ketone, such as acetone, methyl ethyl ketone, methyl isobutyl ketone, cyclohexanone and the like; (3) ester, such as methyl acetate, ethyl acetate, butyl acetate, diethyl oxalate, diethyl malonate, ethylene glycol monoethyl ether acetate and the like; (4) ether, such as diethyl ether, ethylene glycol methyl ether, ethylene glycol ethyl ether, ethylene glycol n-propyl ether, ethylene glycol isopropyl ether, ethylene glycol n-butyl ether, ethylene glycol dimethyl ether, diethylene glycol dimethyl ether and the like; (5) halohydrocarbon, such as dichloromethane, 1,2-dichloro ethane, 1,4-dichloro butane, trichloroethane, chlorobenzene, m-dichlorobenzene and the like; (6) hydrocarbon, such as tetrahydrofuran, hexane, heptane, octane, benzene, toluene, xylene and the like, or a combination thereof. Based on an amount of the diamine compound (b) as 100 parts by weight, the amount of the poor solvent preferably 0 to 60 parts by weight, and more preferably 0 to 50 parts by weight.

Method of Producing Polyimide

A mixture is dissolved in a solvent, and a polymerization reaction is performed to form polyamic acid. The aforementioned mixture includes a tetracarboxylic dianhydride component (a) and a diamine component (b). Then, polyamic acid is heated to subject a dehydration ring-closure reaction in the presence of a dehydrating agent and a catalyst. The amic acid group of the polyamic acid is converted to an imide group by the dehydration ring-closure reaction, that is to say imidization, so as to form polyimide.

The solvent used in the dehydration ring-closure reaction can be the same as the solvent in the liquid crystal alignment agent and is not illustrated any more here. Based on polyamic acid as 100 parts by weight, the amount of the solvent used in the dehydration ring-closure reaction preferably 200 to 2000 parts by weight, and more preferably 300 to 1800 parts by weight.

The operating temperature of the dehydration ring-closure reaction preferably is 40° C. to 200° C. for getting a better imidization ratio of the polyamic acid. More preferably, the aforementioned temperature is 40° C. to 150° C. When the operating temperature of the dehydration ring-closure reaction is lower than 40° C., the reaction is incomplete, thereby lowering the imidization ratio of the polyamic acid. However, when the operating temperature is higher than 200° C., the weight-average molecular weight of the polyimide is lower.

The imidization ratio of the polymer (A) is 30% to 90%, preferably 35% to 85%, and more preferably 40% to 80%. When the imidization ratio of the polymer (A) is 30% to 90%, and the liquid crystal alignment agent is applied in the liquid crystal display element, the liquid crystal alignment agent has excellent UV reliability.

The dehydrating agent used in the dehydration ring-closure reaction is selected from the group consisting of acid anhydride compound. For example, the acid anhydride compound is acetic anhydride, propionic anhydride, trifluoroacetic anhydride and the like. Based on the polyamic acid as 1 mole, the amount of the dehydrating agent is 0.01 moles to 20 moles. The catalyst used in the dehydration ring-closure reaction is selected from (1) pyridine compound, such as pyridine, trimethyl pyridine, dimethyl pyridine and the like; (2) tertiary amine compound, such as triethyl amine and the like. Based on the dehydrating agent as 1 mole, the amount of the catalyst is 0.5 moles to 10 moles.

Method of Producing Polyimide Series Block Copolymer

The polyimide series block-copolymer is selected from the group consisting of the polyamic acid block-copolymer, polyimide block-copolymer, polyamic acid-polyimide block copolymer and a combination thereof.

Preferably, a starting material is firstly dissolved in a solvent, and a polycondensation reaction is performed to produce the polyimide series block-copolymer. The starting material includes at least one aforementioned polyamic acid and/or at least one aforementioned polyimide, and the starting material further comprises a tetracarboxylic dianhydride component (a) and a diamine component (b).

The tetracarboxylic dianhydride component (a) and the diamine component (b) in the starting material are the same as the tetracarboxylic dianhydride component (a) and the diamine component (b) used in the method of producing aforementioned polyamic acid. The solvent used in the polycondensation reaction is the same as the solvent in the liquid crystal alignment agent and is not illustrated any more here.

Based on the starting material as 100 parts by weight, the solvent used in the polymerization reaction preferably is 200 to 2000 parts by weight, and more preferably 300 to 1800 parts by weight. The operating temperature of the polymerization reaction preferably is 0° C. to 200° C., and more preferably 0° C. to 100° C.

Preferably, the starting material includes but is not limited (1) two polyamic acid having different terminal groups and different structures; (2) two polyimide having different terminal groups and different structures; (3) the polyamic acid and the polyimide that have different terminal groups and different structures; (4) the polyamic acid, the tetracarboxylic dianhydride compound and the diamine compound, and the structure of the at least one of the tetracarboxylic dianhydride compound and the diamine compound is different from the structures of the tetracarboxylic dianhydride compound and the diamine compound that are used to form the polyamic acid; (5) the polyimide, the tetracarboxylic dianhydride compound and the diamine compound, and the structure of the at least one of the tetracarboxylic dianhydride compound and the diamine compound is different from the structures of the tetracarboxylic dianhydride compound and the diamine compound that are used to form the polyimide; (6) the polyamic acid, the polyimide, the tetracarboxylic dianhydride compound and the diamine compound, and the structure of the at least one of the tetracarboxylic dianhydride compound and the diamine compound is different from the structures of the tetracarboxylic dianhydride compound and the diamine compound that are used to form the polyamic acid or the polyimide; (7) two polyamic acid, tetracarboxylic dianhydride compounds or diamine compounds, and they have different structures: (8) two polyimide, tetracarboxylic dianhydride compounds or diamine compounds, and they have different structures; (9) two polyamic acid and a diamine compounds, and the two polyamic acid have different structures and the terminal groups of the polyamic acid are acetic anhydride groups; (10) two polyamic acid and a tetracarboxylic dianhydride compound, and the two polyamic acid have different structures and the terminal groups of the polyamic acid are amine groups; (11) two polyimide and a diamine compound, and the two polyimide have different structures and the terminal groups of the polyimide are acid anhydride groups; (12) two polyimide and a tetracarboxylic dianhydride compound, and the two polyimide have different structures and the terminal groups of the polyimide are amine groups.

Preferably, the polyamic acid, the polyimide and the polyimide block copolymer can be terminal-modified polymer after adjusting the molecular weight without departing from the efficiency of the present invention. The terminal-modified polymer can improve a coating ability of the liquid crystal alignment agent. When the polymerization reaction of the polyamic acid is performed, a compound having a monofunctional group is added to produce the terminal-modified polymer. The monofunctional group includes but is not limited (1) monoacid anhydride, such as maleic anhydride, phthalic anhydride, Itaconic anhydride, n-decyl succinic anhydride, n-dodecyl succinic anhydride, n-tetradecyl succinic anhydride, n-hexadecyl succinic anhydride and the like; (2) monoamine compound, such as aniline, cyclohexaylamine, n-butylamine, n-pentylamine, n-hexylamine, n-heptylamine, n-octylamine, n-nonylamine, n-decylamine, n-undecylamine, n-dodecylamine, n-tridecylamine, n-tetradecylamine, n-pentadecylmaine, n-hexadecylamine, n-heptadecylamine, n-octadecylamine, n-eicosylamine and the like; (3) monoisocyanate compound, such as phenyl isocyanate, naphthyl isocyanate and the like.

### Solvent (B)

The solvent (B) of the present invention is N-methyl-2-pyrrolidone, γ-butyrolactone, γ-butyrolactam, 4-hydroxyl-4-methyl-2-pentanone, ethylene glycol monomethyl ether, butyl lactate, butyl acetate, methylmethoxypropionate, ethylethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether aceate, diglycol monoethyl ether aceate, N,N-dimethylformamide, N,N-dimethylethanamide and the like. The solvent (B) can be used alone or in a combination of two or more.

Based on an amount of the polymer (A) as 100 parts by weight, the amount of the solvent (B) is 500 parts by weight to 3000 parts by weight, preferably is 800 pars by weight to 2500 parts by weight, and more preferably is 1000 parts by weight to 2000 parts by weight.

### A Compound Having at Least Two Epoxy Groups (C)

The liquid crystal alignment agent of the present invention can selectively include a compound having at least two epoxy groups (C).

The compound (C) having at least two epoxy groups (C) can include but is not limited ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, 2,2-dibromo-neopentyl diglycidyl ether, 1,3,5,6tetraglycidyl-2,4-hexanediol, N,N,N′,N′-tetraglycidyl-m-xylene diamine, 1,3-bis(N,N-diglycidylaminomethyl)cyclohexane, N,N,N′,N′-tetraglycidyl-4,4′-diaminodiphenylmethane, N,N-glycidyl-p-glycidoxy aniline, 3-(N-allyl-N-glycidyl)aminopropyltrimethoxyl silane, 3-(N,N-diglycidyl)aminopropyl trimethoxyl silane and the like.

The compound having at least two epoxy groups (C) can be used alone or in a combination of two or more.

Based on an amount of the polymer (A) as 100 parts by weight, an amount of the compound having at least two epoxy groups (C) is less than 40 parts by weight, and preferably is 0.1 parts by weight to 30parts by weight.

### Additive (D)

The liquid crystal alignment agent can selectively include an additive (D) without departing from the efficiency of the present invention. The additive (D) is a functional group-containing silane compound. The additive (D) can raise the adhesion between the liquid crystal alignment film and the surface of the substrate. The additive (D) can be used alone or in a combination of two or more.

The functional group-containing silane compound includes but is not limited 3-aminopropyl trimethoxy silane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylene triamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyl triethoxysilane, N-bis(oxyethylene)-3-aminopropyltrimethoxysilane, N-bis(oxyethylene)-3-aminopropyltriethoxysilane and the like.

Based on an amount of the polymer (A) as 100 parts by weight, the amount of the functional group-containing silane compound is less than 10 parts by weight, and preferably is 0.5 parts by weight to 10 parts by weight.

### Producing Liquid Crystal Alignment Agent

The liquid crystal alignment agent of the present invention is produced by a conventional mixing method. For example, the tetracarboxylic dianhydride component (a) and the diamine component (b) are mixed uniformly to produce the polymer (A). Then, the polymer (A) is added to the solvent (B) at 0° C. to 200° C. in a mixer until all compositions are mixed uniformly, and the compound having at least two epoxy groups (C) and the additive (D) can selectively be added. Preferably, the solvent (B) is added into the polymer (A) at 20° C. to 60° C.

### Producing Liquid Crystal Alignment Film

The producing method of the liquid crystal alignment film comprises the following steps. The aforementioned liquid crystal alignment agent firstly is coated on a surface of a substrate to form a coating film by a roller coating, a spin coating, a printing coating, an ink-jet printing and the like. Then, a pre-bake treatment, a post-bake treatment and an alignment treatment are subject to the coating film to produce the liquid crystal alignment film.

The organic solvent in the coating film is volatilized by the aforementioned pre-bake treatment. The operating temperature of the pre-bake treatment is 30° C. to 120° C., preferably 40° C. to 110° C., and more preferably 50° C. to 100° C.

The alignment treatment does not have any limitations. The liquid crystal alignment film is rubbed along a desired direction with a roller that is covered with a cloth made from fibers such as nylon, rayon, cotton and the like. The aforementioned alignment treatment is widely known rather than focusing or mentioning them in details.

The polymer in the coating film is further subjected to the dehydration ring-closure (imidization) reaction by the post-bake treatment. The operating temperature of the post-bake treatment is 150° C. to 300° C., preferably 180°C. to 280° C., and more preferably 200° C. to 250° C.

### Producing Method of Liquid Crystal Display Element

The producing method of the liquid crystal display element is widely known rather than focusing or mentioning them in details.

Reference is made to FIG. 1, which is a cross-sectional diagram of a liquid crystal display element according to the present invention. in a preferable example, the liquid crystal display element 100 includes a first unit 110, a second unit 120 and a liquid crystal unit 130. The second unit 120 is spaced apart opposite the first unit 110, and the liquid crystal unit 130 is disposed between the first unit 110 and the second unit 120.

The first unit 110 includes a first substrate 111, a first conductive film 113 and a first liquid crystal alignment film 115. The first conductive film 113 is disposed on a surface of the first substrate 111, and the first liquid crystal alignment film 115 is disposed on a surface of the first conductive film 113.

The second unit 120 includes a second substrate 121, a second conductive film 123 and a second liquid crystal alignment film 125. The second conductive film 123 is disposed on a surface of the second substrate 121, and the second liquid crystal alignment film 125 is disposed on a surface of the second conductive film 123.

The first substrate 111 and the second substrate 121 are selected from a transparent material and the like. The transparent material includes but is not limited an alkali-free glass, a soda-lime glass, a hard glass (Pyrex glass), a quartz glass, polyethylene terephthalate, polybutylene terephthalate, polyethersulfone, polycarbonate and the like. The materials of the first conductive film 113 and the second conductive film 123 are selected from tin oxide (SnO₂), indium oxide-tin odide (In₂O₃—SnO₂) and the like.

The first liquid crystal alignment film 115 and the second liquid crystal alignment film 125 respectively are the aforementioned liquid crystal alignment films, which can provide the liquid crystal unit 130 with a pretilt angle. The liquid crystal unit 130 is driven by an electric field induced by the first conductive film 113 and the second conductive film 123.

A liquid crystal material used in the liquid crystal unit 130 can be used alone or in a combination of two or more. The liquid crystal material includes but is not limited diaminobenzene liquid crystal, pyridazine liquid crystal, Shiff Base liquid crystal, azoxy liquid crystal, biphenyl liquid crystal, phenyl cyclohexane liquid crystal, ester liquid crystal, terphenyl liquid crystal, biphenyl cyclohexane liquid crystal, pyrimidine liquid crystal, dioxane liquid crystal, bicyclooctane liquid crystal, cubane liquid crystal and the like. Optionally, the liquid crystal material includes cholesterol liquid crystal, such as cholesteryl chloride, cholesteryl nonanoate, cholesteryl carbonate and the like; chiral agent, such as products made by Merck Co. Ltd., and the trade name are C-15 and CB-15; ferroelectric liquid crystal, such as p-decoxyl benzilidene-p-amino-2-methyl butyl cinnamate and the like.

Several embodiments are described below to illustrate the application of the present invention. However, these embodiments are not used for limiting the present invention. For those skilled in the art of the present invention, various variations and modifications can be made without departing from the spirit and scope of the present invention.

### BRIEF DESCRIPTION OF THE DRAWINGS

The invention can be more fully understood by reading the following detailed description of the embodiment, with reference made to the accompanying drawings as follows:

FIG. 1 is a cross-sectional diagram of a liquid crystal display element according to the present invention.

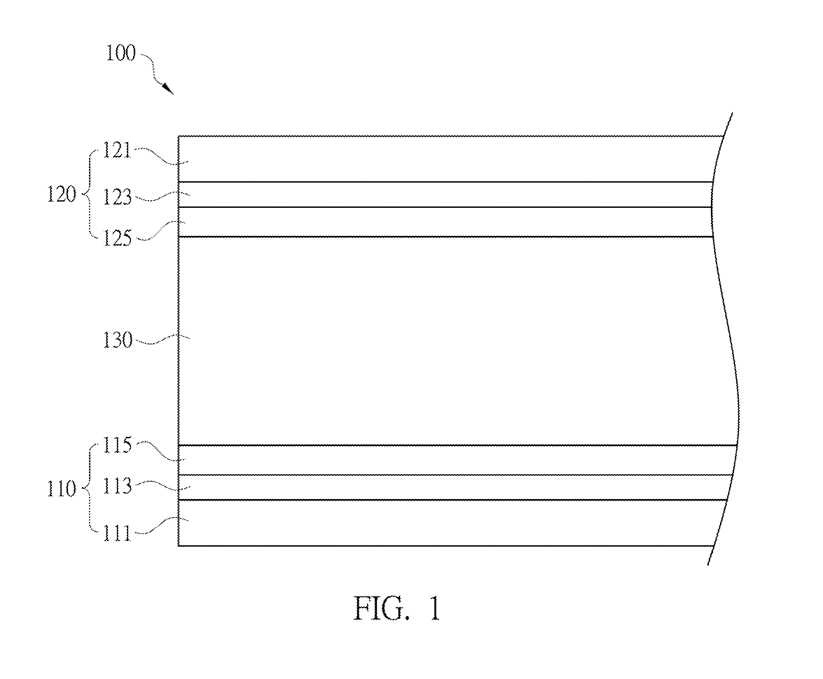

### DETAILED DESCRIPTION

### Producing Polymer (A)

The polymer (A) of Synthesis Examples A-1-1 to A-2-10 and Comparative Synthesis Examples A-3-1 to A-3-8 were according to Table 1 and Table 2 as follows.

### SYNTHESIS EXAMPLE A-1-1

A 500 ml four-necked conical flask equipped with a nitrogen inlet, a stirrer, a condenser and a thermometer was purged with nitrogen. Then, 0.13 g (0.0005 mole) of the diamine compound (b-1-1) having a structure of formula (IV-1), 5.35 g (0.0495 mole) of p-diaminobenzene (b-2-1) and 80 g of N-methyl-2-pyrrolidinone were mixed uniformly at room temperature. Next, 1.75 g (0.0025 mole) of [9,9-bis(4′-hydroxyphenyl)fluorene-bis(trimellitate anhydride); a-1-1], 8.82 g (0.045 mole) of 1,2,3,4-cyclobutane tetracarboxylic dianhydride (a-2-1), 0.49 g (0.0025 mole) of butane tetracarboxylic dianhydride (a-2-4) and 20 g of N-methyl-2-pyrrolidinone were added and left to react for 2 hours at room temperature. When the reaction; is completed, the reacting solution was poured into 1500 ml of water to precipitate the polymer. The polymer obtained after filtering was repeatedly washed using methanol and filtered thrice, and then placed into a vacuum oven, where drying was carried out at 60° C. thereby obtaining a polymer (A-1-1). An imidization ratio of the resulted polymer (A-1-1) was evaluated according to the following evaluation method, and the result thereof was listed as Table 1. The evaluation method of the imidization ratio was described as follows.

### SYNTHESIS EXAMPLES A-1-2 TO A-1-5

Synthesis Examples A-1-2 to A-1-5 were practiced with the same method as in Synthesis Example A-1-1 by using various kinds or amounts of the components for the polymer. The formulations and detection results thereof were listed in Table 1 rather than focusing or mentioning them in details.

### SYNTHESIS EXAMPLE A-2-1

A 500 ml four-necked conical flask equipped with a nitrogen inlet, a stirrer, a heater, a condenser and a thermometer was purged with nitrogen. Then, 0.13 g (0.0005 mole) of the diamine compound (b-1-1) having a structure of formula (IV-1), 5.35 g (0.0495 mole) of p-diaminobenzene (b-2-1) and 80 g of N-methyl-2-pyrrolidinone were mixed uniformly at room temperature. Next, 1.75 g (0.0025 mole) of [9,9-bis(4′-hydroxyphenyl)fluorene-bis(trimellitate anhydride); a-1-1], 8.82 g (0.045 mole) of 1,2,3,4-cyclobutane tetracarboxylic dianhydride (a-2-1), 0.49 g (0.0025 mole) of butane tetracarboxylic dianhydride (a-2-4) and 20 g of N-methyl-2-pyrrolidinone were added to subject to a reaction. After the reaction is performed for 6 hours at room temperature, 97 g of N-methyl-2-pyrrolidinone, 2.55 of acetic anhydride and 19.75 g of pyridine were added at 60° C. and left to stir for 2 hours for imidization reaction. When the reaction is completed, the reacting solution was poured into 1500 ml of water to precipitate the polymer. The polymer obtained after filtering was repeatedly washed using methanol and filtered thrice, and then placed into a vacuum oven, where drying was carried out at 60° C., thereby obtaining a polymer (A-2-1). An imidization ratio of the resulted polymer (A-2-1) was evaluated according to the following evaluation method, and the result thereof was listed as Table 1.

### SYNTHESIS EXAMPLES A-2-2 TO A-2-10

Synthesis Examples A-2-2 to A-2-10 were practiced with the same method as in Synthesis Example A-2-1 by using various kinds or amounts of the compositions for the polyimide. The formulations and detection results thereof were listed in Table 1 rather than focusing or mentioning them in details.

### COMPARATIVE SYNTHESIS EXAMPLES A-3-1 TO A-3-3 AND COMPARATIVE SYNTHESIS EXAMPLE A-3-6

Comparative Synthesis Examples A-3-1 to A-3-3 and Comparative Synthesis Example A-3-6 were practiced with the same method as in Synthesis Example A-1-1 by using various kinds or amounts of the compositions for the polymer. The formulations and detection results thereof were listed in Table 2 rather than focusing or mentioning them in details.

### COMPARATIVE SYNTHESIS EXAMPLES A-3-4 TO A4-5 AND COMPARATIVE SYNTHESIS EXAMPLES A-3-7 TO A-3-8

Comparative Synthesis Examples A-3-4 to A-3-5 and Comparative Synthesis Examples A-3-7 to A-3-8 were practiced with the same method as in Synthesis Example A-2-1 by using various kinds or amounts of the compositions for the polyimide. The formulations and detection results thereof were listed in Table 2 rather than focusing or mentioning them in details.

### Producing Liquid Crystal Alignment Agent

Hereinafter, the liquid crystal alignment agents of Examples 1 to 15 and Comparative Examples 1 to 8 were according to Table 3 and Table 4 as follows.

### EXAMPLE 1

100 parts by weight of the polymer (A-1-1) was added into 1200 parts by weight of N-methyl-2-pyrrolidinone (hereinafter abbreviated as B-1) and 600 parts by weight of ethylene glycol n-butyl ether (hereinafter abbreviated as B-2) for mixing in a mixer until all compounds were mixed uniformly at room temperature, thereby obtaining the liquid crystal alignment agent of Example 1. The resulted liquid crystal alignment agent was evaluated according to the following evaluation method, and the result thereof was listed as Table 3. The evaluation methods of the UV reliability were described as follows.

### EXAMPLES 2 to 15 AND COMPARATIVE EXAMPLES 1 TO 8

Examples 2 to 15 and Comparative Examples 1 to 8 were practiced with the same method as in Example 1 by using various kinds or amounts of the compositions for the liquid crystal alignment agent. The formulations and detection results thereof were listed in Table 3 and Table 4 rather than focusing or mentioning them in details.

### Evaluation Methods

### 1. Imidization Ratio

The imidization ratio refers to a ratio of the number of imide ring in the total amount of the number of amic acid functional group and the number of imide ring in the polymer (A), and the imidization ratio is presented by percentage.

After the aforementioned method of reduced pressure drying is performed, the polymer (A) of Synthesis Examples A-1-1 to A-2-10 and Comparative Synthesis Examples A-3-1 to A-3-8 respectively were dissolved in a suitable deuteration solvent, such as deuterated dimethyl sulfoxide. ¹H-NMR (hydrogen-nuclear magnetic resonance) was detected at room temperature (25° C.) using tetramethylsilane as a standard, and the imidization ratio (%) was calculated according to the following formula (VII):

$$Imidization Ratio ( \% ) = [ 1 - \frac{Δ 1}{Δ 2 \times α} ] \times 100 \% \qquad ( VII )$$

in the formula (V), Δ1 is the peak area of the chemical shift induced by the proton of NH group near 10 ppm, Δ2 is the peak area of other proton, and α is the ratio of one proton of NH group corresponding to the number of other proton in the polyamic acid precursor.

### 2. UV Reliability

The liquid crystal films were respectively made by the liquid crystal alignment agents of the aforementioned Examples 1 to 15 and the Comparative Examples 1 to 8, and the liquid crystal display elements having the same were fabricated. Voltage holding ratios of the liquid crystal display elements were respectively detected by an electrical measuring machine (manufactured by TOYO Corporation, and the trade name is Model 6254). A voltage of 4 volts was applied for 2 milliseconds. The applied voltage was held for 1667 milliseconds. After the applied voltage was cut off for 1667 milliseconds, the voltage holding ratio (VHR1) was measured. Then, the liquid crystal display elements were exposed by UV light. An energy of the UV light is 4200 mJ/cm², and UV lighting machine is made by kuangneng Co., and the trade name is KN-SH48K1. After the liquid crystal display element was exposed, the voltage holding ratio (VHR2) was measured with the same parameters. UV reliability (VHR^{UV}) was calculated according to the following formula (VIII), and an evaluation was made according to the following criterion:

$$V H {R}^{UV} = \frac{V H R 1 - V H R 2}{V H R 1} \times 100 \% \qquad ( VIII )$$

⊚: VHR^{UV}<5%;

◯: 5%≦VHR^{UV}<10%;

Δ: 10%≦VHR^{UV}<20%;

×: 20%≦VHR^{UV}.

According to Table 1 to Table 4, when the tetracarboxylic dianhydride component (a) of the polymer (A) includes the tetracarboxylic dianhydride compound (a-1) and the diamine component (b) includes the diamine compound (b-1), the liquid crystal alignment agent has excellent UV reliability.

Moreover, when the imidization ratio of the polymer (A) is 30% to 90%, the liquid crystal alignment agent has more excellent UV reliability.

It should be supplemented that, although specific compounds, components, specific reactive conditions, specific processes, specific evaluation methods or specific equipments are employed as exemplary embodiments of the present invention, for illustrating the liquid crystal alignment agent, the liquid crystal alignment film and the liquid crystal display element having thereof of the present invention. However, as is understood by a person skilled in the art instead of limiting to the aforementioned examples, the liquid crystal alignment agent, the liquid crystal alignment film and the liquid crystal display element having thereof of the present invention also can be manufactured by using other compounds, components, reactive conditions, processes, analysis methods and equipment without departing from the spirit and scope of the present invention.

As is understood by a person skilled in the art, the foregoing preferred embodiments of the present invention are illustrated of the present invention rather than limiting of the present invention. In view of the foregoing, it is intended to cover various modifications and similar arrangements included within the spirit and scope of the appended claims. Therefore, the scope of which should be accorded the broadest interpretation so as to encompass all such modifications and similar structure.

TABLE 1

| | | | Synthesis Example | | | | | | | | | | | | | | |
|---|---|---|---|---|---|---|---|---|---|---|---|---|---|---|---|---|---|
| Composition (mole %) | | | A-1-1 | A-1-2 | A-1-3 | A-1-4 | A-1-5 | A-2-1 | A-2-2 | A-2-3 | A-2-4 | A-2-5 | A-2-6 | A-2-7 | A-2- | A-2-9 | A-2-10 |
| Tetracarboxylic | Tetracarboxylic | a-1-1 | 5 | | | | 50 | 5 | | | | 50 | | 80 | | | 10 |
| Dianhydride | Dianhydride | a-1-2 | | 10 | | 1 | | | 10 | | 1 | | 30 | | | 70 | 10 |
| Compound | Compound | a-1-3 | | | 30 | | | | | 30 | | | 30 | | 40 | | |
| (a) | (a-1) | | | | | | | | | | | | | | | | |
| | Other | a-2-1 | 90 | | | | | 90 | | | | | | | | | 80 |
| | Tetracarboxylic | a-2-2 | | 90 | | | 50 | | 90 | | | 50 | | | 30 | | |
| | Dianhydride | a-2-3 | | | 70 | 90 | | | | 70 | 90 | | 40 | | 30 | | |
| | Compound | a-2-4 | 5 | | | 9 | | 5 | | | 9 | | | 20 | | 30 | |
| | (b-2) | | | | | | | | | | | | | | | | |
| Diamine | Diamine | b-1-1 | 1 | | | | | 1 | | | | | 40 | | | 50 | 10 |
| Compound | Compound | b-1-2 | | 20 | | | 30 | | 20 | | | 30 | | | 6 | | |
| (b) | (b-1) | b-1-3 | | | 50 | | 30 | | | 50 | | 30 | | 10 | | 25 | |
| | | b-1-4 | | | | 80 | | | | | 80 | | | 20 | | | |
| | Other | b-2-1 | 99 | | | | | 99 | | | | | 30 | 40 | 55 | | 60 |
| | Diamine | b-2-2 | | 80 | | | 40 | | 80 | | | 40 | 30 | | | | 30 |
| | Compound | b-2-3 | | | 50 | | | | | 50 | | | | 30 | 20 | 25 | |
| | (b-2) | b-2-4 | | | | 20 | | | | | 20 | | | | 20 | | |

| | | | | | | | | | | | | | | | |
|---|---|---|---|---|---|---|---|---|---|---|---|---|---|---|---|
| Imidization Ratio (%) | 0 | 0 | 0 | 0 | 0 | 15 | 20 | 26 | 30 | 42 | 55 | 67 | 73 | 90 | 95 |

a-1-1 9,9-bis(4′-hydroxyphenyl)fluorene-bis(trimellitate anhydride)
a-1-2 9,9-bis(4′-hydroxy-3′-methylphenyl)fluorene-bis(trimellitate anhydride)
a-1-3 the tetracarboxylic dianhydride compound having a structure of formula (I)
a-2-1 1,2,3,4-cyclobutene tetracarboxylic dianhydride
a-2-2 pyromellitic dianhydride
a-2-3 2,3,5-tricarboxy cyclopentyl acetic acid dianhydride
a-2-4 butane tetracarboxylic dianhydride
b-1-1 the diamine compound having a structure of formula (IV-1)
b-1-1 the diamine compound having a structure of formula (IV-8)
b-1-1 the diamine compound having a structure of formula (IV-12)
b-1-1 the diamine compound having a structure of formula (IV-4)
b-2-1 p-diaminobenzene
b-2-2 4,4′-diaminodiphenylmethane
b-2-3 1-octadecoxy-2,4-aminobenzene
b-2-4 the diamine compound having a structure of formula (VI-29)

TABLE 2

| | | | Comparative Synthesis Example | | | | | | | |
|---|---|---|---|---|---|---|---|---|---|---|
| Composition (mole %) | | | A-3-1 | A-3-2 | A-3-3 | A-3-4 | A-3-5 | A-3-6 | A-3-7 | A-3-8 |
| Tetracarboxylic | Tetracarboxylic | a-1-1 | | | | | 80 | | | |
| Dianhydride | Dianhydride | a-1-2 | | 10 | | | | | | |
| Compound | Compound | a-1-3 | | | | | | | | |
| (a) | (a-1) | | | | | | | | | |
| | Other | a-2-1 | 90 | | 30 | 50 | | 50 | 50 | 50 |
| | Tetracarboxylic | a-2-2 | | 90 | | 50 | | 50 | 50 | 50 |
| | Dianhydride | a-2-3 | | | 70 | | | | | |
| | Compound | a-2-4 | 10 | | | | 20 | | | |
| | (b-2) | | | | | | | | | |
| Diamine | Diamine | b-1-1 | 1 | | | | | 117 | | |
| Compound | Compound | b-1-2 | | | | 30 | | | | |
| (b) | (b-1) | b-1-3 | | | | 30 | | | | |
| | | b-1-4 | | | | | | | | |
| | Other | b-2-1 | 99 | 20 | 50 | | 70 | | 94 | |
| | Diamine | b-2-2 | | 80 | | 40 | | | | 80 |
| | Compound | b-2-3 | | | 50 | | 30 | | 6 | |
| | (b-2) | b-2-4 | | | | | | | | |

| | | | | | | | | |
|---|---|---|---|---|---|---|---|---|
| Imidization Ratio (%) | 0 | 0 | 0 | 42 | 67 | 0 | 55 | 62 |

a-1-1 9,9-bis(4′-hydroxyphenyl)fluorene-bis(trimellitate anhydride)
a-1-2 9,9-bis(4′-hydroxy-3′-methylphenyl)fluorene-bis(trimellitate anhydride)
a-1-3 the tetracarboxylic dianhydride compound having a structure of formula (I)
a-2-1 1,2,3,4-cyclobutene tetracarboxylic dianhydride
a-2-2 pyromellitic dianhydride
a-2-3 2,3,5-tricarboxy cyclopentyl acetic acid dianhydride
a-2-4 butane tetracarboxylic dianhydride
b-1-1 the diamine compound having a structure of formula (IV-1)
b-1-1 the diamine compound having a structure of formula (IV-8)
b-1-1 the diamine compound having a structure of formula (IV-12)
b-1-1 the diamine compound having a structure of formula (IV-4)
b-2-1 p-diaminobenzene
b-2-2 4,4′-diaminodiphenylmethane
b-2-3 1-octadecoxy-2,4-aminobenzene
b-2-4 the diamine compound having a structure of formula (VI-29)

TABLE 3

| Composition | | Example | | | | | | | | | | | | | | |
|---|---|---|---|---|---|---|---|---|---|---|---|---|---|---|---|---|
| (Parts by Weight) | | 1 | 2 | 3 | 4 | 5 | 6 | 7 | 8 | 9 | 10 | 11 | 12 | 13 | 14 | 15 |
| Polymer (A) | A-1-1 | 100 | | | | | | | | | | | | | | |
| | A-1-2 | | 100 | | | | | | | | | | | | | |
| | A-1-3 | | | 100 | | | | | | | | | | | | |
| | A-1-4 | | | | 100 | | | | | | | | | | | |
| | A-1-5 | | | | | 100 | | | | | | | | | | |
| | A-2-1 | | | | | | 100 | | | | | | | | | |
| | A-2-2 | | | | | | | 100 | | | | | | | | |
| | A-2-3 | | | | | | | | 100 | | | | | | | |
| | A-2-4 | | | | | | | | | 100 | | | | | | |
| | A-2-5 | | | | | | | | | | 100 | | | | | |
| | A-2-6 | | | | | | | | | | | 100 | | | | |
| | A-2-7 | | | | | | | | | | | | 100 | | | |
| | A-2-8 | | | | | | | | | | | | | 100 | | |
| | A-2-9 | | | | | | | | | | | | | | 100 | 50 |
| | A-2-10 | | | | | | | | | | | | | | | 50 |
| | A-3-1 | | | | | | | | | | | | | | | |
| | A-3-2 | | | | | | | | | | | | | | | |
| | A-3-3 | | | | | | | | | | | | | | | |
| | A-3-4 | | | | | | | | | | | | | | | |
| | A-3-5 | | | | | | | | | | | | | | | |
| | A-3-6 | | | | | | | | | | | | | | | |
| | A-3-7 | | | | | | | | | | | | | | | |
| | A-3-8 | | | | | | | | | | | | | | | |
| Solvent (B) | B-1 | 1200 | | 800 | | | 1000 | 900 | 850 | 1400 | | | 800 | 400 | | 1200 |
| | B-2 | 600 | 1600 | | 800 | 1500 | | 300 | 850 | | 1000 | | 750 | 400 | 1200 | 300 |
| | B-3 | | | 1000 | 800 | 100 | 600 | 300 | | | 350 | 1500 | | 400 | 250 | |
| Compound (C) | C-1 | | | | | | | | | 5 | | | 3 | | | |
| | C-2 | | | | | 10 | | | | | | | 5 | | | 2 |
| Evaluation | UV reliability | ◯ | ◯ | ◯ | ◯ | ◯ | ◯ | ◯ | ◯ | ⊚ | ⊚ | ⊚ | ⊚ | ⊚ | ⊚ | ◯ |
| Method | | | | | | | | | | | | | | | | |

B-1 N-methyl-2-pyrrolidinone
B-2 ethylene glycol n-butyl ether
B-3 N,N-dimethylacetamide
C-1 N,N,N′,N′-tetraglycidyl-4,4′-diaminodiphenylmethane
C-2 N,N-glycidyl-p-glycidoxy aniline

TABLE 4

| Composition | | Comparative Example | | | | | | | |
|---|---|---|---|---|---|---|---|---|---|
| (Parts by Weight) | | 1 | 2 | 3 | 4 | 5 | 6 | 7 | 8 |
| Polymer | A-1-1 | | | | | | | | |
| (A) | A-1-2 | | | | | | | | |
| | A-1-3 | | | | | | | | |
| | A-1-4 | | | | | | | | |
| | A-1-5 | | | | | | | | |
| | A-2-1 | | | | | | | | |
| | A-2-2 | | | | | | | | |
| | A-2-3 | | | | | | | | |
| | A-2-4 | | | | | | | | |
| | A-2-5 | | | | | | | | |
| | A-2-6 | | | | | | | | |
| | A-2-7 | | | | | | | | |
| | A-2-8 | | | | | | | | |
| | A-2-9 | | | | | | | | |
| | A-2-10 | | | | | | | | |
| | A-3-1 | 100 | | | | | | | |
| | A-3-2 | | 100 | | | | | | |
| | A-3-3 | | | 100 | | | | | |
| | A-3-4 | | | | 100 | | | | |
| | A-3-5 | | | | | 100 | | | |
| | A-3-6 | | | | | | 100 | | |
| | A-3-7 | | | | | | | 100 | |
| | A-3-8 | | | | | | | | 100 |
| Solvent | B-1 | 1200 | | 800 | | | 1000 | 800 | 800 |
| (B) | B-2 | 600 | 1600 | | 800 | 1500 | | | |
| | B-3 | | | 1000 | 800 | 100 | 600 | 1000 | 1000 |
| Compound | C-1 | | | | | | | | |
| (C) | C-2 | | | | | 10 | | | |
| Evaluation | UV | X | X | X | X | X | X | X | X |
| Method | reli- | | | | | | | | |
| | ability | | | | | | | | |

B-1 N-methyl-2-pyrrolidinone
B-2 ethylene glycol n-butyl ether
B-3 N,N-dimethylacetamide
C-1 N,N,N′,N′-tetraglycidyl-4,4′-diaminodiphenylmethane
C-2 N,N-glycidyl-p-glycidoxy aniline

What is claimed is:

1. A liquid crystal alignment agent, comprising:
a polymer (A), synthesized by reacting a mixture that includes a tetracarboxylic dianhydride component (a) and a diamine component (b); and
a solvent (B); and
wherein the tetracarboxylic dianhydride component (a) us selected from at least one tetracarboxylic dianhydride compound (a-1) having a structure of formula (I) to (III), and the diamine component (b) includes at least one diamine compound (b-1) having a structure of formula (IV): 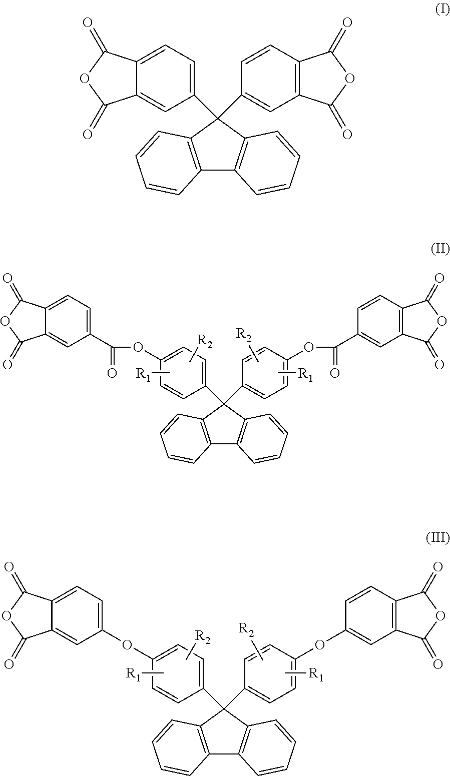
in the formula (I) to (III), the R₁ represents a hydrogen atom, an alkyl group of 1 to 6 carbon atoms, or a single ring or condensed polycyclic aromatic group of 6 to 14 carbon atoms; and the R₂ represents a hydrogen atom, an alkyl group of 1 to 6 carbon atoms, a single ring or condensed polycyclic aromatic group of 6 to 14 carbon atoms; 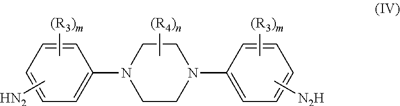
in the formula (IV), the R₃ independently represents a monovalent organic group; the R₄ independently represents a monovalent organic group; m represents an integer of 0 to 3; and n represents an integer of 0 to 4.

2. The liquid crystal alignment agent of claim 1, in the formula (IV), the R₃ independently represents an alkyl group of 1 to 10 carbon atoms, an alkoxy group of 1 to 10 carbon atoms, an acetyl amino group, a fluorine atom, a chloride atom or a bromine atom; and the R₄ independently represents an alkyl group of 1 to 3 carbon atoms.

3. The liquid crystal alignment agent of claims 1, in the formula (IV), phenyl groups of two ends include p-amino groups.

4. The liquid crystal alignment agent of claims 2, in the formula (IV), phenyl groups of two ends include p-amino groups.

5. The liquid crystal alignment agent of claim 1, based on an amount of the tetracarboxylic dianhydride component (a) as 100 moles, the tetracarboxylic dianhydride compound (a-1) having a structure of formula (III) is 1 mole to 80 moles.

6. The liquid crystal alignment agent of claim 1 based on an amount of the diamine component (b) as 100 moles, an amount of the diamine compound (b-1) is 1 mole to 80 moles.

7. The liquid crystal alignment agent of claim 1, further comprising a compound having at least two epoxy groups (C).

8. The liquid crystal alignment agent of claim 1, wherein an imidization ratio of the polymer (A) is 30% to 90%.

9. A liquid crystal alignment film, formed by a liquid crystal alignment agent of claim 1.

10. A liquid crystal display element, comprising a liquid crystal alignment film of claim 9.
